(19) United States
(12) Patent Application Publication
(10) Pub. No.: US 2024/0140790 A1
(43) Pub. Date: May 2, 2024

(54) PYROLYSIS SYSTEMS AND METHODS OF GENERATING HYDROGEN GAS FROM A HYDROCARBON GAS

(71) Applicant: Purdue Research Foundation, West Lafayette, IN (US)

(72) Inventors: Guillermo Paniagua-Perez, West Lafayette, IN (US); Sergio Grasa Martinez, West Lafayette, IN (US); Nesrin Ozalp, Schereville, IN (US)

(21) Appl. No.: 18/499,801

(22) Filed: Nov. 1, 2023

Related U.S. Application Data
(60) Provisional application No. 63/381,971, filed on Nov. 2, 2022.

(51) Int. Cl. C01B 3/24; B01D 45/14; B01D 45/16; B01D 49/00; C01B 3/50

(52) U.S. Cl. CPC C01B 3/24; B01D 45/14; B01D 45/16; B01D 49/006; C01B 3/50; C01B 2203/0272; C01B 2203/049; C01B 2203/0866

(57) ABSTRACT

Pyrolysis systems and methods of generating hydrogen gas from a hydrocarbon gas. The pyrolysis systems include a solar thermal reactor configured to heat a gaseous hydrocarbon stream, such as methane, to its dissociation temperature. A supersonic turbomachine disposed in a housing receives resulting carbon particles and hydrogen gas from the solar thermal reactor and prevents dissociated carbon from forming deposits on an interior wall of the housing. A particulate separator is located downstream of the supersonic turbomachine to separate the carbon particles from the remaining hydrogen gas.

### CROSS-REFERENCE TO RELATED APPLICATIONS

This application claims the benefit of U.S. Provisional Application No. 63/381,971 filed Nov. 2, 2022, the contents of which are incorporated herein by reference.

### BACKGROUND OF THE INVENTION

The invention generally relates to pyrolysis systems and methods capable of generating hydrogen gas from hydrocarbon gases. The invention particularly relates to solar thermal methane pyrolysis systems and methods capable of producing clean hydrogen.

Methane (CH₄) pyrolysis (also called methane cracking and methane decomposition) is a process that can be generally described by the following reaction.

CH₄→2H₂ (gas)+C (solid) (Equation 1)

The reaction has an activation energy in the range of 172 kJ/mol to 440 kJ/mol. Thus, 37.8 kJ is needed to produce one mole of hydrogen from methane, which requires less than 10% of the heat of methane combustion to drive the process. The source of thermal heating to attain the activation energy may be supplied by burning feedstock, via electrification, or via solar thermally.

Methane pyrolysis via solar thermal processing (herein sometimes referred to as a solar thermal methane pyrolysis process) yields hydrogen and carbon (C) with 8% upgraded higher heating values due to the added solar energy entry into a pyrolysis reactor (a reaction chamber commonly called a solar reactor or solar thermal reactor) in which the process is performed. FIG. 1 illustrates a methane pyrolysis (decomposition) system adapted to perform methane pyrolysis via solar thermal pyrolysis in a solar thermal reactor to yield essential products demanded by a myriad of industrial processes. In the basic mechanism of a solar thermal methane pyrolysis process, concentrated solar energy is directed to a solar thermal reactor, where gaseous methane is injected and absorbs energy via convection and radiation. Solar thermal energy is used to raise the methane gas to the necessary dissociation temperature and start the intensive endothermic thermal pyrolysis of methane into hydrogen gas and solid carbon. In this manner, solar radiation is converted into chemical energy via Equation 1 above.

Despite its attractiveness, one challenge of the methane pyrolysis process is the formation of carbon deposits as a result of the pyrolysis process, regardless of the source of the thermal heating method. Carbon deposition within a pyrolysis reactor can occur within milliseconds upon the dissociation of carbon from methane. The buildup of carbon deposits adversely affects process continuation due to reactor clogging, increasing maintenance, and operational costs. Therefore, it would be desirable to have a way to reduce the deposition and buildup of carbon in pyrolysis reactors.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, pyrolysis systems and methods capable of generating hydrogen gas from hydrocarbon gases.

According to one nonlimiting aspect of the invention, a pyrolysis system includes a solar thermal reactor having a housing configured to heat a gaseous hydrocarbon stream to its dissociation temperature yielding a hydrogen gas and a solid carbon. A supersonic turbomachine is disposed in the housing and configured to receive the hydrogen gas and solid carbon from the solar thermal reactor and prevent dissociated carbon from forming deposits on an interior wall of the housing. A particulate separator is located downstream of the supersonic turbomachine. The particulate separator is configured to separate at least a majority of the carbon particles from the hydrogen gas.

According to another nonlimiting aspect of the invention, a method of generating hydrogen gas from a hydrocarbon gas includes heating a stream of hydrocarbon gas to its dissociation temperature in a reactor to dissociate the hydrocarbon gas into carbon particles and hydrogen gas, passing the carbon particles and hydrogen gas through a supersonic turbomachine that removes at least a majority of the carbon particles from the interior wall of the reactor, and separating the carbon particles from the hydrogen gas.

These and other aspects, arrangements, features, and/or technical effects will become apparent upon detailed inspection of the figures and the following description.

### BRIEF DESCRIPTION OF THE DRAWINGS

FIG. 1 is a diagrammatic view of a hydrocarbon pyrolysis (decomposition) system adapted to perform methane pyrolysis via solar thermal pyrolysis in a solar thermal reactor.

FIG. 2 is a diagrammatic cross-sectional view of a hydrocarbon pyrolysis device according to a nonlimiting embodiment of the invention.

FIG. 3 is a partial illustration of two blade rows in a supersonic turbomachine in the device FIG. 2.

FIG. 4 illustrates a shock pattern between airfoils and results of a computational simulation.

FIG. 5 is a diagrammatic cross-sectional view of a pyrolysis system according to another nonlimiting embodiment of the invention.

FIG. 6 illustrates a supersonic turbomachine stage of the system of FIG. 5.

FIG. 7 illustrates calculations of the leading edge shocks in a supersonic compressor.

FIG. 8 illustrates calculations of the leading edge shocks in a supersonic compressor in a counterrotating configuration.

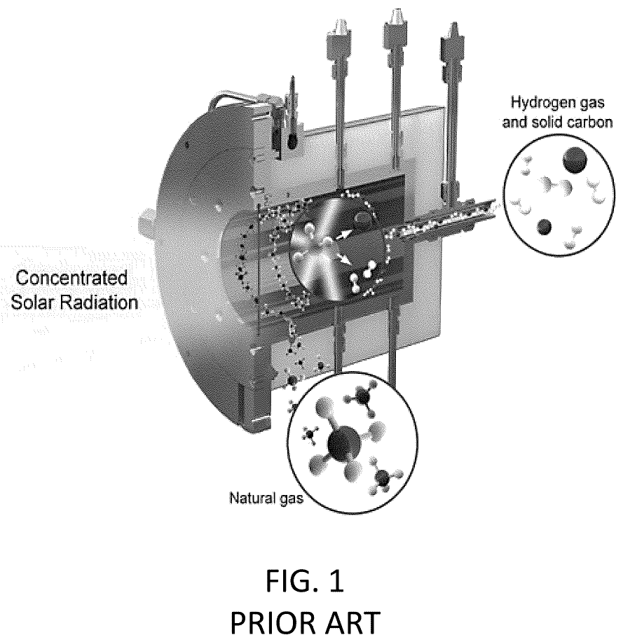

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The present disclosure provides one or more systems and methods that are preferably capable of reducing the deposition and buildup of carbon in pyrolysis (cracking) reactors after the carbon has been dissociated from methane gas or another hydrocarbon. Carbon particles are caused to experience shorter flow time and are exposed to high surface shear stresses to reduce carbon accumulation on the wall of a pyrolysis reactor. According to some aspects of the present invention, high-speed rotating supersonic turbomachines can be used to enhance a traditional pyrolysis reactor by improving the energy transfer efficiency and have the potential to minimize carbon deposition by sweeping carbon particles off the wall of the reactor.

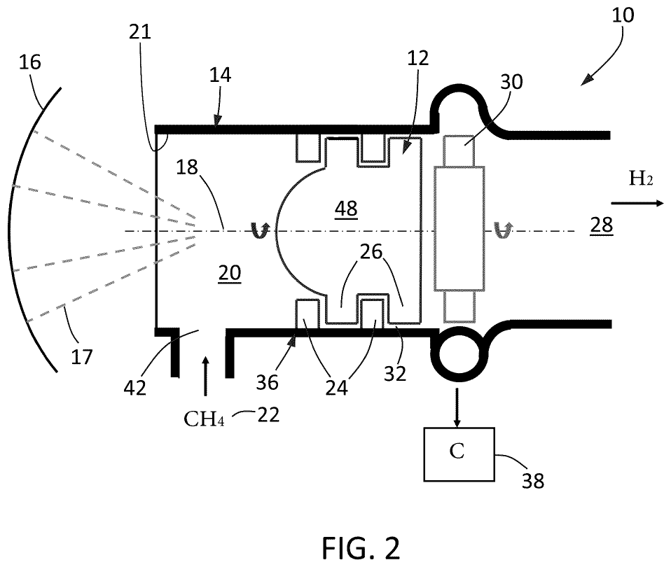

Turning now to the drawings, FIG. 2 schematically represents a pyrolysis system 10 that includes a supersonic turbomachine 12 integrated with a solar thermal reactor 14 forming a unique hub for hydrocarbon pyrolysis as a combined system. In this example, the pyrolysis system 10 is represented as a solar methane pyrolysis system, but it is possible that the fundamental concepts of the system 10 could be used for pyrolyzing other types of hydrocarbons in the gaseous phase and/or the use of other types of heat energy sources. A solar radiation collector (heater) 16, such as a concave and/or parabolic reflector, collects, directs, and concentrates solar radiation 17 into the solar thermal reactor 14 at a focal point 18 inside a reaction chamber 20 within the reactor 14. Methane 22 in gaseous form enters the reaction chamber 20 circumferentially from an inlet port 42 with an injection angle of about 10° to about 20°, with a preferred injection angle of about 30° at the neck of the solar thermal reactor 14. The injected gaseous methane 22 is directly heated by solar radiation to its dissociation temperature, thereby yielding hydrogen gas and solid carbon. The hydrogen gas and solid carbon flow axially from the reaction chamber 20 to and along the supersonic turbomachine 12 located in a passage 32 of a housing (casing) 36 immediately downstream from the reaction chamber 20. The passage 32 may simply be a portion of the solar thermal reactor 14 and/or the passage 32 may extend from the solar thermal reactor 14. In this example, the supersonic turbomachine 12 is disposed within the solar thermal reactor 14 between the focal point 18 and an outlet 28 of the passage 32 and is surrounded by an interior wall 21 of the reaction chamber 20. It is contemplated that additional arrangements are possible.

The supersonic turbomachine 12 includes a series of alternating adjacent stationary and rotating rows of vanes 24 and blades 26, respectively, placed circumferentially as represented in FIG. 3. The blades 26 of the supersonic turbomachine 12 rotate about an axis at a speed in the range of 600 and 700 meters/second. By rotating at these speeds (about two times the speed of sound), the rotating blades 26 create supersonic flows within the turbomachine 12 with intense oblique shock waves.

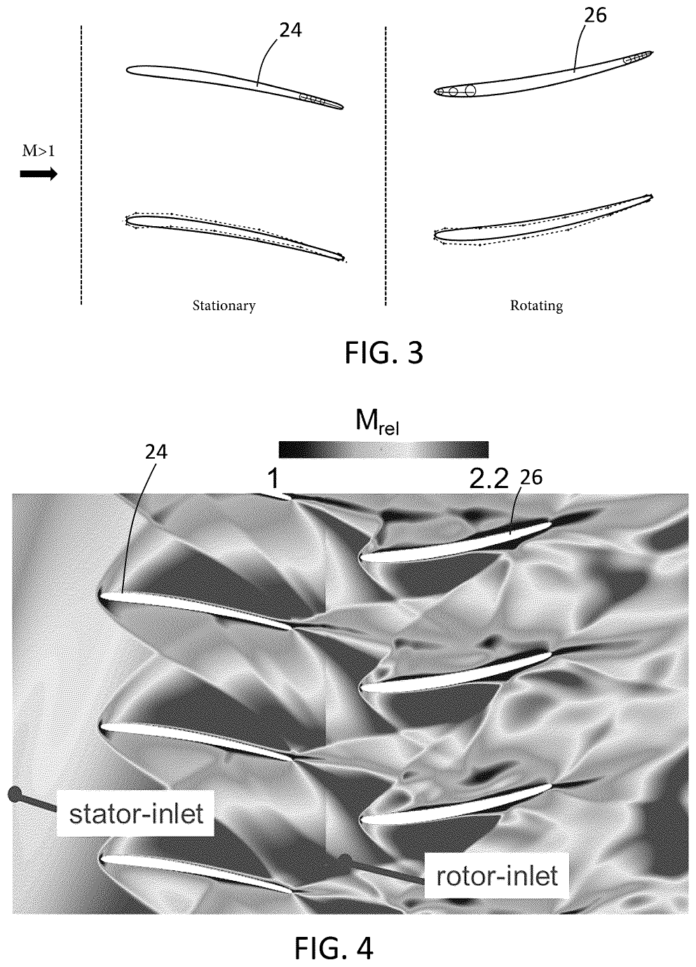

As illustrated in FIG. 4, the vanes 24 and blades 26 are capable of creating strong shock waves and shock-boundary layer interactions. FIG. 4 represents a shock pattern between airfoils (vanes 24 and blades 26) in a supersonic turbine from a computational simulation. The forming of the shock waves creates jumps in static temperature and pressure, which creates large increases in the shear stresses, scraping the carbon particles as they are being solidified and deposited on the wall 21 through the pyrolysis process. The shock reflections ensure that the solid particles of carbon are effectively removed from the wall 21 and pushed downstream along the passage 32. The supersonic operation of the turbomachine 12 enables a very compact and/or small size for the system 10.

As shown in FIG. 2, a particulate separator 30, such as a supersonic radial cyclone, is located downstream of the supersonic turbomachine 12 and separates at least a majority of the carbon particles from the hydrogen gas. The separated carbon particles are directed into a downstream collector unit 38 while the remaining hydrogen gas is directed to the outlet 28 downstream of the separator 30.

In some embodiments, the supersonic turbomachine 12 of the pyrolysis system 10 is a supersonic axial turbine that is integrated with the solar thermal reactor 14. The necessary endothermic heat to the fluid is provided by solar radiation 17, and thereby imposes no specific heating requirement on the supersonic turbomachine 12 itself. Due to the supersonic operation of the turbomachine 12, the pyrolysis system 10 can operate with smaller blades 26 than other bladed reactors, which reduces manufacturing costs and provides a more compact system. In addition, high velocity and shock waves mitigate solid particle deposition. The airfoil designs of the pyrolysis system 10 shown in FIGS. 3 and 4 preferably operate in supersonic flow along the entire passage 32. Thus, the overall residence time of the heated methane gas and subsequent hydrogen gas and solid carbon within the reaction chamber 20 and along the passage 32 is reduced while increasing the surface heat transfer and shear stresses, enabling a faster reaction and more effective separation of carbon particles from the hydrogen gas.

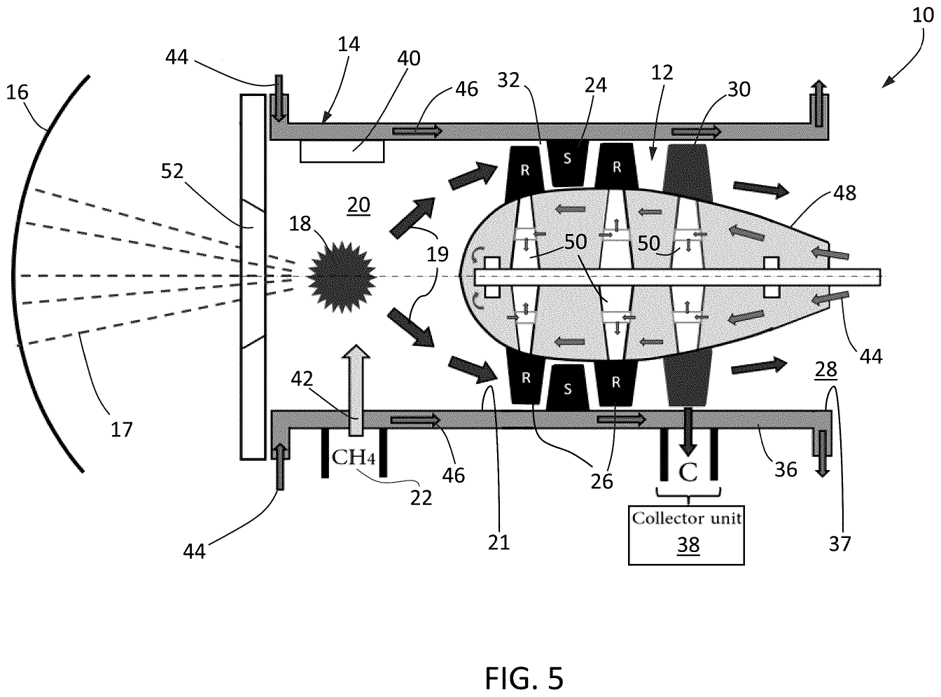

FIG. 5 illustrates another embodiment of a pyrolysis system 10 according to principles of the present invention. For convenience, identical reference numerals are used in FIG. 5 to denote the same or functionally related/equivalent elements described for the system 10 of FIG. 2. In view of similarities between these embodiments, the following discussion of FIG. 5 will focus primarily on aspects of the embodiment of FIG. 5 that differ from the embodiment of FIG. 2 in some notable or significant manner. Other aspects of the embodiment of FIG. 5 not discussed in any detail can be, in terms of structure, function, materials, etc., essentially as was described for the embodiment of FIG. 2.

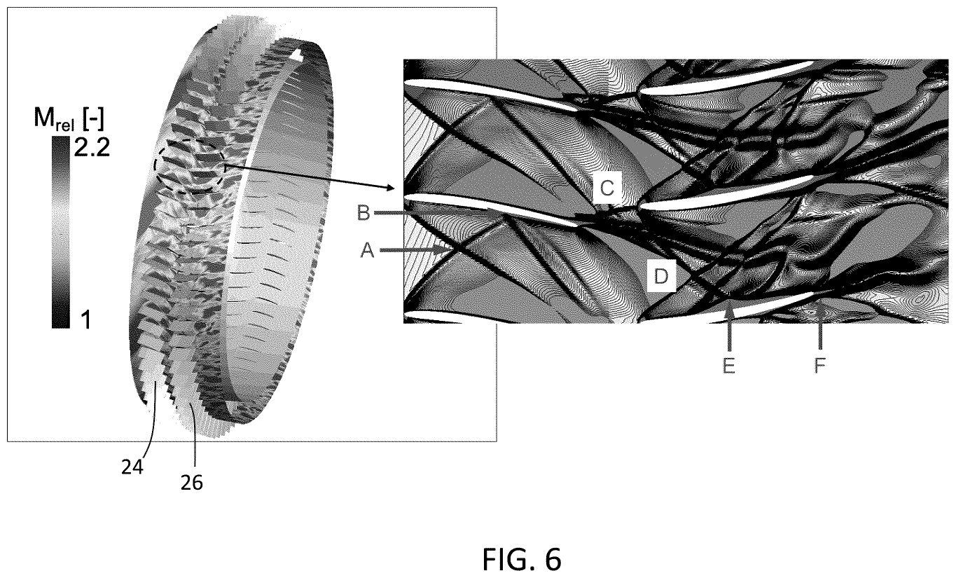

As with the system 10 of FIG. 2, the pyrolysis system 10 of FIG. 5 includes a solar thermal reactor 14, a solar radiation collector 16, a supersonic turbomachine 12 located in a passage 32 of a housing (casing) 36 immediately downstream from a reaction chamber 20, and a supersonic radial separator (cyclone) 30 downstream of the supersonic turbomachine 12 to separate dissociated carbon particles from hydrogen gas produced by the pyrolysis process performed with the system 10. The supersonic turbomachine 12 is represented as being integrated with the solar thermal reactor 14. The housing 36 houses both the solar thermal reactor 14 and the supersonic turbomachine 12, as well as the radial separator 30. In this arrangement, the solar thermal reactor 14 is equipped with dual heating modes to provide the necessary endothermic heat for driving the methane pyrolysis process: a high flux solar heater (simulator) such as the solar radiation collector 16, and an induction heater 40. The solar radiation collector 16 and the induction heater 40 may be used interchangeably to compensate for the inherently transient nature of the solar energy. The solar radiation collector 16 collects and directs concentrated solar radiation 17 into the reaction chamber 20 of the solar thermal reactor 14 at the focal point 18. The induction heater 40 may be selectively engaged to provide replacement heat when insufficient solar radiation 17 is available, for example at night, and/or to supplement the heat produced by the solar radiation collector 16. Gaseous methane 22 enters through the inlet port 42 at the neck of the solar thermal reactor 14, and the gaseous methane 22 is directly heated by the focused solar radiation 17 to its dissociation temperature, thereby yielding a mixture 19 of hydrogen gas and solid carbon, which flows axially along the supersonic turbomachine 12, including rotating blades 26 thereof. As shown in the left side of FIG. 6, the blades 26 are arranged in rows placed circumferentially around a rotor. The blades 26 of the supersonic turbomachine 12 rotate about an axis at a speed of about two times the speed of sound (e.g., about 600 to about 700 meters/second). During the rotation of the blades 26 at these speeds, supersonic flows of the hydrogen gas and solid carbon are created with intense oblique shock waves. The supersonic blades 26 create strong shock waves and shock-boundary layer interactions. In this example, one row of stationary vanes 24 that extends radially inwardly from the housing 36 along the passage 32 is disposed axially between two rows of rotating blades 26 that project radially outwardly from a hub 48 of the supersonic turbomachine 12. Other arrangements for the supersonic turbomachine 12 are possible.

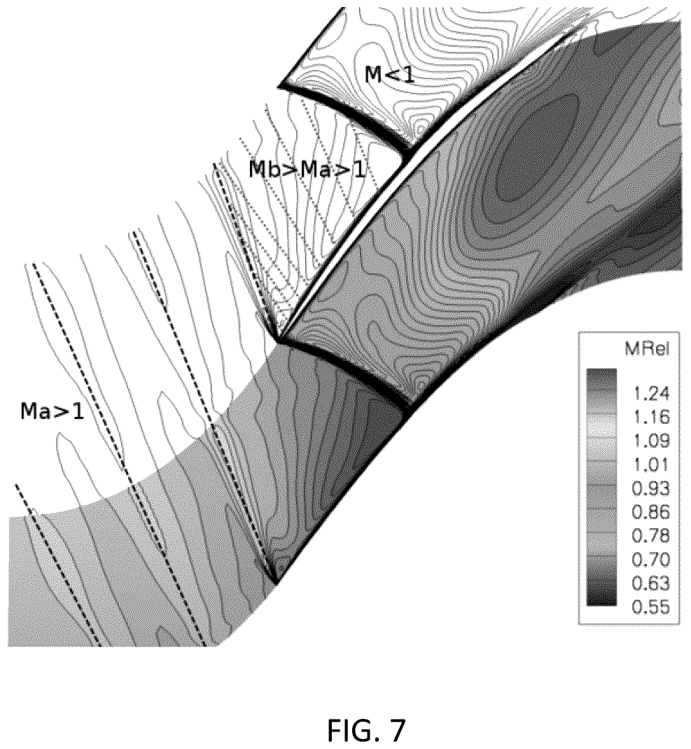

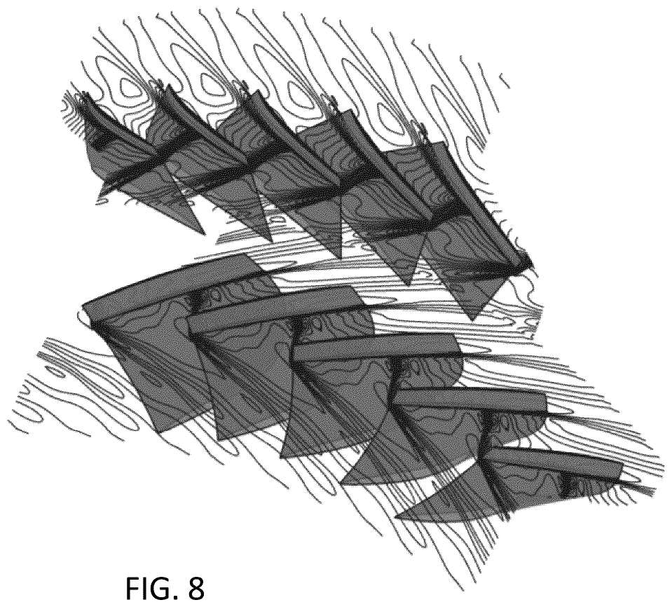

The geometry of the supersonic turbomachine 12 may be optimized to enhance the amplitude of the distortion across the passage 32. FIG. 6 illustrates a 3D view of a computational simulation of the supersonic turbomachine stage with very complex shock wave interactions. At ‘A,’ two leading-edge shocks interact and generate two oblique shocks. At 13,′ a weak shock boundary layer interaction can be observed. At ‘C,’ reflected shocks from 13′ interact with the stator trailing edge shock. At 13,′ multiple shocks interact. At ‘E,’ strong shock boundary layer interaction is observed, which leads to a low subsonic pocket. At ‘F,’ a rotor trailing edge shock is observed. FIG. 7 shows a computational simulation of leading edge shocks in a supersonic compressor. Strong shock waves (highlighted in black) induce sudden jumps in the flow conditions, creating large steps in the shear stress, significantly reducing solid particle deposition along one or more walls 37 of the housing 36 downstream from the reaction chamber 20. FIG. 8 represents the shock pattern between airfoils in a supersonic compressor with a counterrotating configuration. The strength of a shock and its propagation downstream into the next blade row create a complex flow field where the carbon deposits are scraped from all surfaces and pushed further downstream of the supersonic turbomachine 12.

In the embodiment illustrated in FIG. 5 the supersonic radial separator 30 extends radially outwardly from the hub 48 of the supersonic turbomachine 12 and is connected to the main shaft, rotating together with the rotating rows of blades 26. Other arrangements for the number of shafts and spinning direction are possible.

The pyrolysis system 10 optionally includes a cooling system to cool the walls 37 of the housing 36 and/or the hub 48 of the supersonic turbomachine 12 that are in contact with the heated stream. In this example, the walls 37 are cooled with a flow of coolant 44, such as nitrogen, flowing through one or more cooling channels 46 within or along the walls 37. The cooling of the walls 37 limits the formation of carbon deposits in the housing 36. In addition, the hub 48 of the supersonic turbomachine 12 is also cooled by a flow of coolant 44, such as nitrogen. In this example, the coolant 44 circulates through the hub 48 by entering at a downstream end of the supersonic turbomachine 12, circulating along interior walls of the hub 48 and through rotor disks 50 therein toward an upstream end of the hub 48, after which the coolant 44 exists the hub 48 through a central shaft of the hub 48. Other cooling arrangements could be used.

A window 52 upstream of the reaction chamber 20 is configured to allow collected solar radiation to enter into the reaction chamber 20. The window 52 may be formed of glass or other suitable material to allow passage of the collected solar radiation from the collector 16 into the reaction chamber 20. Preferably, the window 52 is also sealed to retain heat in the reaction chamber 20.

The pyrolysis systems 10 of either FIG. 2 or FIG. 5 may be used to implement a method of generating hydrogen gas from a hydrocarbon gas, such as methane gas, in accordance with aspects of the invention. In a first step, a stream of the hydrocarbon gas (e.g., methane) is heated in the reactor 14 to its dissociation temperature to dissociate the hydrocarbon gas into carbon particles and hydrogen gas. The hydrocarbon may be heated with the solar heater (e.g., collector 16) and/or the induction heater 40. The heated stream of hydrocarbon gas is then immediately passed into and through the supersonic turbomachine 12, which removes the dissociated carbon particles from the interior walls 21 and 37 of the reaction chamber 20 and housing 36, respectively, that are in contact with the dissociating stream of hydrocarbon gas. Shock waves from the supersonic speed of the heated gas through the supersonic turbomachine 12 contribute to the removal of and/or prevention of accumulation of carbon particles on the interior walls 21 and 37. Thereafter, the carbon particles are separated from the hydrogen gas with the radial separator 30, and the carbon particles are collected in the collector unit 38 while the hydrogen gas is directed out the outlet 28. Thereafter, the hydrogen gas may be collected for further use and/or processing.

As previously noted above, though the foregoing detailed description describes certain aspects of one or more particular embodiments of the invention, alternatives could be adopted by one skilled in the art. For example, the pyrolysis systems and their components could differ in appearance and construction from the embodiments described herein and shown in the drawings, functions of certain components of the pyrolysis systems could be performed by components of different construction but capable of a similar (though not necessarily equivalent) function, and various materials could be used in the fabrication of the pyrolysis systems and/or their components. As such, and again as was previously noted, it should be understood that the invention is not necessarily limited to any particular embodiment described herein or illustrated in the drawings.

1. A pyrolysis system comprising:
a solar thermal reactor having a housing configured to heat a gaseous hydrocarbon stream to its dissociation temperature yielding hydrogen gas and solid carbon;
a supersonic turbomachine disposed in the housing, wherein the supersonic turbomachine is configured to receive the hydrogen gas and solid carbon from the solar thermal reactor and prevent the solid carbon from forming deposits on an interior wall of the housing; and
a particulate separator located downstream of the supersonic turbomachine, wherein the particulate separator is configured to separate at least a majority of the solid carbon from the hydrogen gas.

2. The pyrolysis system of claim 1, wherein the hydrocarbon stream comprises methane.

3. The pyrolysis system of claim 1, wherein the supersonic turbomachine comprises a row of stationary vanes adjacent a row of rotating blades.

4. The pyrolysis system of claim 3, wherein the row of stationary vanes adjacent the row of rotating blades is configured to form shock waves capable of removing the solid carbon from the interior wall of the housing.

5. The pyrolysis system of claim 3, wherein the row of stationary vanes adjacent the row of rotating blades is configured to rapidly increase static temperature and pressure within the housing resulting in increased shear stresses between the solid carbon and the interior wall.

6. The pyrolysis system of claim 3, wherein the blades of the supersonic turbomachine rotate at a speed in a range of 600 and 700 meters/second.

7. The pyrolysis system of claim 1, wherein the particulate separator comprises a supersonic radial cyclone.

8. The pyrolysis system of claim 1, wherein the solar thermal reactor comprises a heater.

9. The pyrolysis system of claim 8, wherein the heater comprises a solar radiation collector.

10. The pyrolysis system of claim 8, wherein the heater comprises an induction heater.

11. The pyrolysis system of claim 10, wherein the induction heater is configured to be selectively engaged to supplement and/or replace heat supplied by a solar heater.

12. The pyrolysis system of claim 1, wherein the supersonic turbomachine is configured to produce shock waves that remove carbon particles from the interior wall.

13. A method of generating hydrogen gas from a hydrocarbon gas, the method comprising:
heating a stream of hydrocarbon gas to its dissociation temperature in a reactor to dissociate the hydrocarbon gas into carbon particles and hydrogen gas;
passing the carbon particles and hydrogen gas through a supersonic turbomachine that removes the carbon particles from an interior wall of the reactor; and
separating at least a majority of the carbon particles from the hydrogen gas.

14. The method of claim 13, wherein the hydrocarbon gas comprises methane.

15. The method of claim 13, wherein the step of heating comprises heating the stream of hydrocarbon gas with a solar radiation collector.

16. The method of claim 13, wherein the step of separating comprises passing the carbon particles and hydrogen gas through a supersonic radial cyclone.

17. The method of claim 16, wherein the supersonic turbomachine comprises an axial turbine.

18. The method of claim 17, wherein removing the carbon particles comprises forming shock waves in the heated stream of hydrocarbon gas with blades of the supersonic turbomachine.

19. The method of claim 17, wherein blades on the turbine rotate at a speed in a range of 600 to 700 meters/second.

20. The method of claim 19, wherein rotation of the blades increases shear stresses between the carbon particles and the interior wall.
